(19) United States
(12) Patent Application Publication
(10) Pub. No.: US 2025/0380245 A1
(43) Pub. Date: Dec. 11, 2025

(54) SHARED RADIO FREQUENCY RESOURCES FOR MSIM TRANSMISSION AND RECEPTION

(71) Applicant: QUALCOMM Incorporated, San Diego, CA (US)

(72) Inventors: Xiaoyu LI, Beijing (CN); Cheol Hee PARK, San Diego, CA (US); Jie QIAO, Beijing (CN); Ling XIE, Beijing (CN); Qingxin CHEN, San Diego, CA (US)

(21) Appl. No.: 18/874,419

(22) PCT Filed: Aug. 19, 2022
(86) PCT No.: PCT/CN2022/113703

§ 371 Date: Dec. 12, 2024

(51) Int. Cl. H04W 72/0446; H04W 52/02; H04W 52/52; H04W 72/0453

(52) U.S. Cl. CPC H04W 72/0446; H04W 52/0216; H04W 52/52; H04W 72/0453

(57) ABSTRACT

Certain aspects of the present disclosure provide techniques for using shared radio frequency resources for multiple subscriber identification module transmission and reception. An example method includes receiving, using a shared set of receive (RX) chains, a plurality of radio frequency (RF) signals in a set of time-frequency resources, wherein the plurality of RF signals include: first RF signals corresponding to first subscription of the UE, and second RF signals corresponding to a second subscription of the UE: processing the first RF signals using a first baseband processor of the UE associated with the first subscription; and processing the second RF signals using a second baseband processor of the UE associated with the second subscription.

### BACKGROUND

### Field of the Disclosure

Aspects of the present disclosure relate to wireless communications, and more particularly, to techniques for using shared radio frequency (RF) resources for multiple subscriber identification module (MSIM) transmission and reception.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving, using a shared set of receive (RX) chains, a plurality of radio frequency (RF) signals in a set of time-frequency resources, wherein the plurality of RF signals include: first RF signals corresponding to first subscription of the UE, and second RF signals corresponding to a second subscription of the UE; processing the first RF signals using a first baseband processor of the UE associated with the first subscription; and processing the second RF signals using a second baseband processor of the UE associated with the second subscription.

Another aspect provides a method for wireless communication by a UE. The method includes processing first radio frequency (RF) signals, corresponding to a first subscription of the UE, using a first baseband processor of the UE for transmission using a shared set of transmit (TX) chains; processing second RF signals, corresponding to a second subscription of the UE, using a second baseband processor of the UE for transmission using the shared set of TX chains; multiplexing the first RF signals corresponding to the first subscription and the second RF signals corresponding to the second subscription to obtain multiplexed RF signals; and transmitting, in a set of time-frequency resources, the multiplexed RF signals using the shared set of TX chains.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a block diagram of an example transceiver front-end.

FIG. 6A provides an illustration of independent radio frequency resources used for reception between subscriptions of an MSIM device.

FIG. 6B provides an illustration of independent radio frequency resources used for transmission between subscriptions of an MSIM device.

FIG. 7 illustrates radio frequency resources of a user equipment that may be used to receive radio frequency signals corresponding to different subscriptions using a shared set of receive chains.

FIG. 8 illustrates radio frequency resources of a user equipment that may be used to transmit radio frequency signals corresponding to different subscriptions using a shared set of transmit chains.

FIG. 9 depicts a method for wireless communications.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for using shared radio frequency (RF) resources for multiple subscriber identification module (MSIM) transmission and reception.

For example, in some cases, a user equipment (UE) may support communication using two or more subscriptions based on two or more subscriber identification module, known as MSIM. These subscriptions may be on the same radio network or different radio networks. In some cases, when communicating using multiple subscriptions, the UE may use separate RF resources for each subscription, such as separate transmit chains, receive chains, transceivers, antennas, etc. Further, each subscription may arrange its own receive and transmit activities independently.

While MSIM operation may generally enhance user experience by allowing communication with multiple subscriptions, RF resources of an MSIM UE used for transmitting and receiving RF signals may be split, but not shared, between each subscription. This may be problematic when the MSIM UE has a limited number of RF resources. For example, assuming that the MSIM UE only has two transmit chains available for transmitting RF signals and two receive chains available for receiving RF signals. When performing MSIM communication using multiple subscriptions (e.g., two), the available transmit and receive chains may be split between the multiple subscriptions. In other words, each subscription may be allocated only one transmit chain and one receive chain of the two available transmit and receive chains. This may result in performance loss associated with each subscription as throughput associated with each subscription may be reduced by about 50 percent as compared to single-SIM operation in which one subscription is able to use both available transmit chains and receive chains.

Accordingly, aspects of the present disclosure provide techniques for reducing this performance loss associated with MSIM operation. For example, in some cases, these techniques may involve using a common or shared set of RF resources (e.g., transmit/receive chains) when transmitting and receiving RF signals corresponding to different subscriptions.

For example, rather than receiving RF signals corresponding to each different subscription using a separate respective receive chain, all receive chains may be shared between the different subscriptions and used to receive the RF signals corresponding to the different subscriptions. In other words, each of the receive chains may be used to receive the RF signals corresponding to each of the different subscriptions. Similarly, rather than transmitting RF signals corresponding to each different subscription using a separate respective transmit chain, RF signals for each different subscription may be multiplexed together and transmitted using a shared set of transmit chains. Accordingly, by using a shared set of RF resources (e.g., transmit/receive chains) when transmitting and receiving RF signals corresponding to different subscriptions, throughput associated with these subscriptions may be improved and performance loss reduced or avoided.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

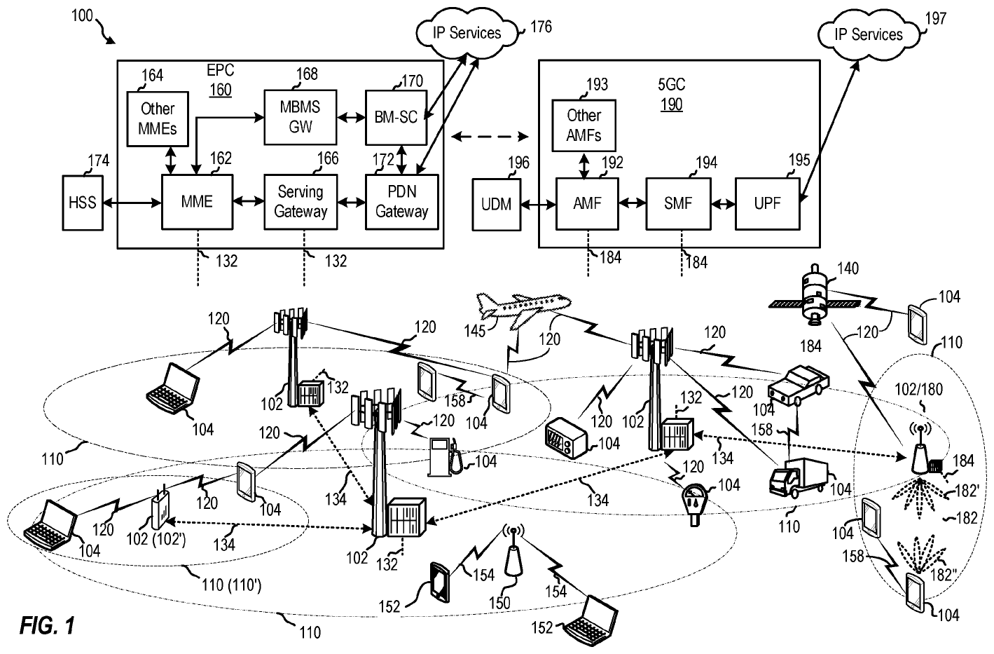

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

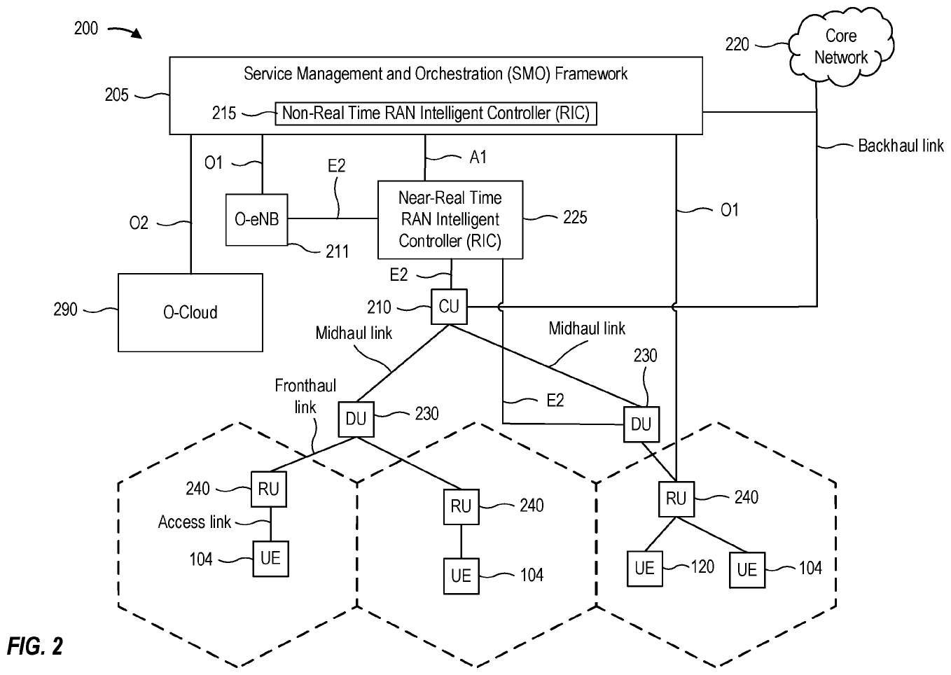

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

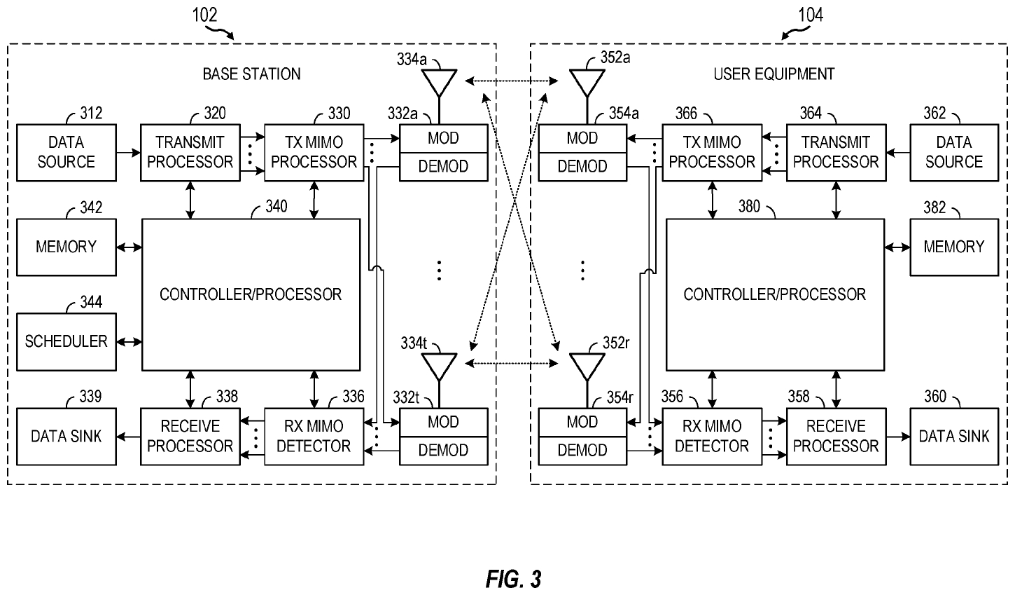

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

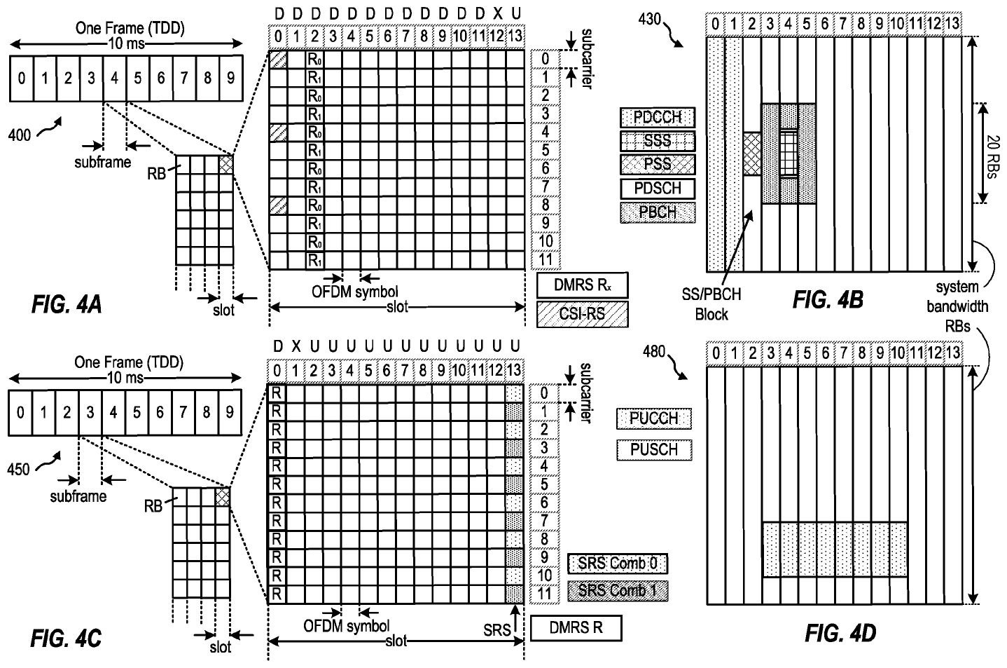

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

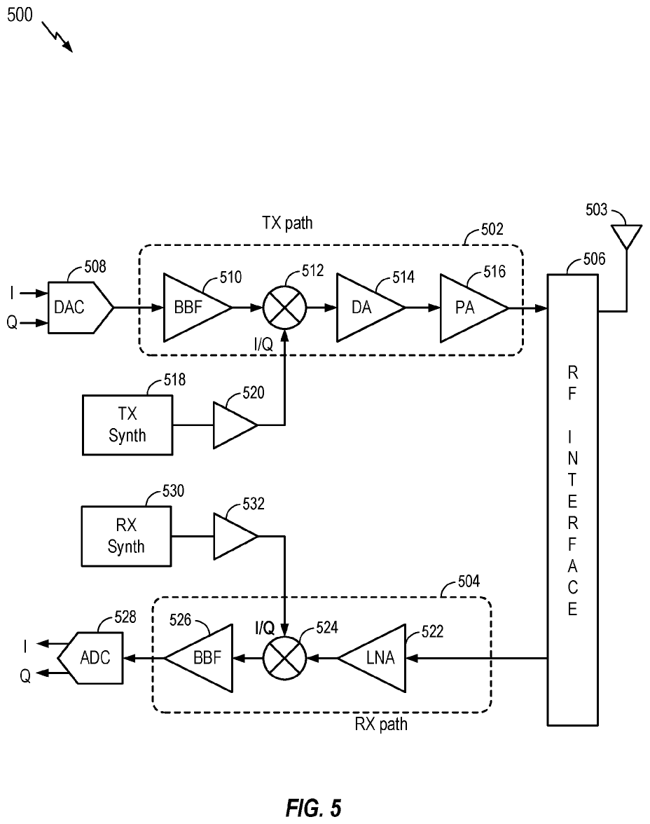

FIG. 5 is a block diagram of an example transceiver front-end 500. The transceiver front-end 500 may be part of a transceiver, such as transceivers 332, 354 illustrated in FIG. 3, in accordance with certain aspects of the present disclosure. The transceiver front-end 500 includes at least one transmit (TX) path 502 (also known as a transmit chain or radio frequency (RF) chain) for transmitting signals via one or more antennas and at least one receive (RX) path 504 (also known as a receive chain or RF chain) for receiving signals via the antennas. When the TX path 502 and the RX path 504 share an antenna 503, the paths may be connected with the antenna via an RF interface 506, which may include any of various suitable RF devices, such as a duplexer, a switch, a diplexer, and the like. While FIG. 5 illustrates one TX chain (e.g., TX path 502 or RF chain) and one RX chain (e.g., RX path 504 or RF chain), it should be understood that the transceiver front-end 500 may include more than one TX chain and one RX chain. That is, the transceiver front-end 500 may include multiple RF chains. In some cases, one or more of the TX path 502 or the RX path 504 may be scheduled to perform operations (e.g., a cell search operations, cell measurement operations, frequency tracking loop operations, time tracking loop operations, radio link monitoring operations, automatic gain control operations) for a plurality of component carriers, as described below.

Receiving in-phase (I) or quadrature (Q) baseband analog signals from a digital-to-analog converter (DAC) 508, the TX path 502 may include a baseband filter (BBF) 510, a mixer 512, a driver amplifier (DA) 514, and a power amplifier (PA) 516. The BBF 510, the mixer 512, and the DA 514 may be included in a radio frequency integrated circuit (RFIC), while the PA 516 may be included in the RFIC or external to the RFIC. The BBF 510 filters the baseband signals received from the DAC 508, and the mixer 512 mixes the filtered baseband signals with a transmit local oscillator (LO) signal to convert the baseband signal of interest to a different frequency (e.g., upconvert from baseband to RF). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 512 are typically RF signals, which may be amplified by the DA 514 and/or by the PA 516 before transmission by the antenna 503.

The RX path 504 may include a low noise amplifier (LNA) 522, a mixer 524, and a baseband filter (BBF) 526. The LNA 522, the mixer 524, and the BBF 526 may be included in a radio frequency integrated circuit (RFIC), which may or may not be the same RFIC that includes the TX path components. RF signals received via the antenna 503 may be amplified by the LNA 522, and the mixer 524 mixes the amplified RF signals with a receive local oscillator (LO) signal to convert the RF signal of interest to a different baseband frequency (i.e., downconvert). The baseband signals output by the mixer 524 may be filtered by the BBF 526 before being converted by an analog-to-digital converter (ADC) 528 to digital I or Q signals for digital signal processing.

While it is desirable for the output of an LO to remain stable in frequency, tuning to different frequencies may indicate using a variable-frequency oscillator, which can involve compromises between stability and tunability. Contemporary systems may employ frequency synthesizers with a voltage-controlled oscillator (VCO) to generate a stable, tunable LO with a particular tuning range. Thus, the transmit LO may be produced by a TX frequency synthesizer 518, which may be buffered or amplified by amplifier 520 before being mixed with the baseband signals in the mixer 512. Similarly, the receive LO may be produced by an RX frequency synthesizer 530, which may be buffered or amplified by amplifier 532 before being mixed with the RF signals in the mixer 524.

### Aspects Related to Shared RF Resources for MSIM Transmission and Reception

In certain cases, two different subscriptions may be supported on a same device, such as a user equipment (UE), and may be based on two separate subscriber identification module (SIMs), known as multi-SIM (MSIM). These subscriptions may be on the same radio network or different radio networks and could have different subscription profiles and quality of service (QOS) requirements. Further, different subscriptions may provide services on the same or different radio access technologies (RATs). Generally, MSIM solutions use fewer resources, while performing operations on two different RATs, than those needed by two independent solutions with the goal of optimizing resource (RF, MIPs, etc.) usage as well as providing an enhanced user experience.

In some cases, different classes of radio frequency (RF) solutions exist for MSIM devices. For example, in some cases, due to RF complexity, cost, and power consumption considerations, an MSIM device may include a single transceiver where two subscriptions share the same radio resources (e.g., transmit chain, receive chain, transceivers, antennas, etc.). In other cases, an MSIM device may include dual transceivers that may provide dual receive and dual access (DSDA). For example, in this case, each subscription of the MSIM device may have separate RF resources (e.g., transmit chains, receive chains, transceivers, antennas, etc.).

When the subscriptions of a MSIM UE use separate RF resources, each subscription may arrange its own RX/TX activities independently. For example, each subscription may (1) perform separate RF tuning (e.g., tuning to different frequency resources), (2) have separate RF sleep/wake schedules, (3) have independent inter-frequency/intra-radio access technology (IRAT) measurement gap scheduling, (4) have independent automatic gain control (AGC) gain state adjustment, and (5) independent baseband frequency tracking loops and time tracking loops.

While MSIM solutions may generally enhance user experience, when an MSIM device has a limited number of RF resources (e.g., RX chains/TX chains), the RX/TX activities of each subscription may experience significant performance losses as these RF resources are split, but not shared, between each subscription. For example, assume that a UE has two RX chains available for reception on an N28 5G frequency band. For single-subscription operation (e.g., single-SIM), the UE may use both RX chains for reception on the N28 frequency band. However, for multi-subscription operation (e.g., MSIM), each subscription may only use one RX chain, of the two RX chains available, for reception on the N28 frequency band.

In another example, assume that the UE has four RX chains available for reception on an N79 5G frequency band. For single-subscription operation (e.g., single-SIM), the UE may use all four RX chains for reception on the N79 frequency band. However, for multi-subscription operation (e.g., MSIM), each subscription may only use two RX chains, of the four RX chains available, for reception on the N79 frequency band. As can be seen, while the UE has multiple RX chains (e.g., RF resources) available for reception, these RX chains are divided between each subscription, which may lead to performance loss for each subscription for MSIM operation as compared to single-SIM operation.

A similar issue exists for transmission. For example, when DSDA MSIM operation is used by the UE and the UE only includes one TX chain, the UE may need to switch between subscriptions when using the TX chain. More specifically, the UE may be permitted to use the TX chain to transmit transmissions for one subscription during a certain period of time and then switch to using the TX chain to transmit transmissions for another transmission during another period of time. In other words, the one TX chain is shared between the two subscriptions. As a result, in the examples discussed above, the direct downlink and uplink throughput loss may exceed over 50 percent, which does take into account throughput losses due to network conditions (e.g., poor signal quality, scheduling conflicts, etc.).

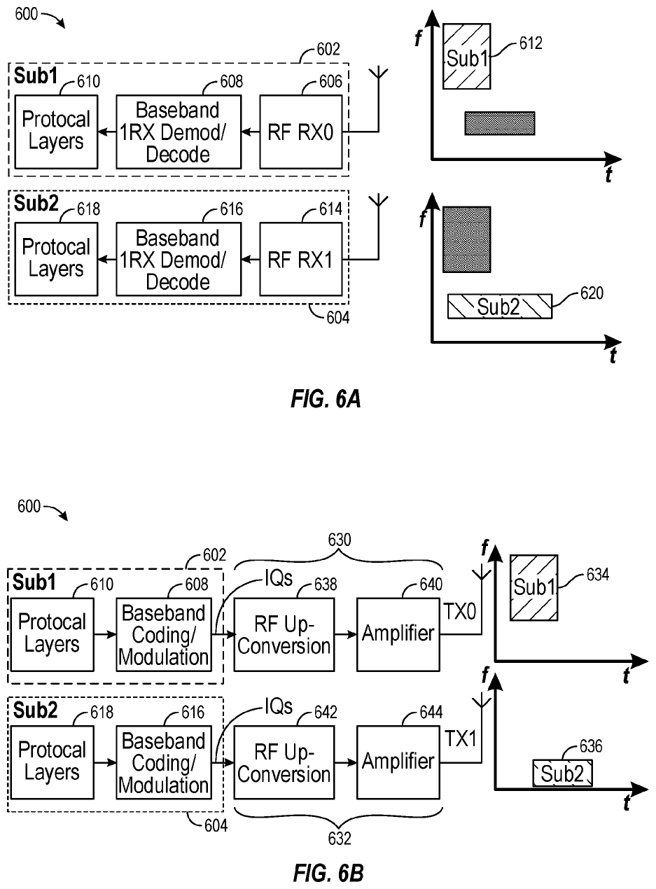

FIG. 6A provides an illustration of independent RF resources used for reception between subscriptions of an MSIM device 600, such as the UE 104. For example, as shown in FIG. 6A, the MSIM device 600 includes a first subscription 602 and a second subscription 604. In some cases, the MSIM device 600 may have a limited number of RF resources and, as a result, RX chains may be split between the first subscription 602 and the second subscription 604. For example, as shown, the MSIM device 600 includes two RX chains split between the first subscription 602 and the second subscription 604, such as a first RX chain 606 (e.g., RF RX0) corresponding to the first subscription 602 and a second RX chain 614 (e.g., RF RX1) corresponding to the second subscription 604.

In some cases, the first RX chain 610 may include an antenna (e.g., antenna 503 illustrated in FIG. 5) and various other components (e.g., ADC 528, BBF 526, mixer 524, LNA 522, RF interface 506 illustrated in FIG. 5) for receiving first RF signals 612 corresponding to the first subscription 602 in a first set of time-frequency resources. First RF signals 612 received by the first RX chain 610 may then be provided to a first baseband processor 608 corresponding to the first subscription 602 for further processing, such as for demodulating and decoding of the first RF signals 612. Thereafter, the demodulated and decoded first RF signals 612 may be provided to protocol layers 610.

Similarly, the second RX chain 614 may include an antenna (e.g., antenna 503 illustrated in FIG. 5) and various other components (e.g., ADC 528, BBF 526, mixer 524, LNA 522, RF interface 506 illustrated in FIG. 5) for receiving second RF signals 620 corresponding to the second subscription 604 in a second set of time-frequency resources. Second RF signals 620 received by the second RX chain 614 may then be provided to a second baseband processor 616 corresponding to the second subscription 604 for further processing, such as for demodulating and decoding of the second RF signals 620. Thereafter, the demodulated and decoded second RF signals 620 may be provided to protocol layers 618.

It should be noted that, in some cases, second RF signals 620 corresponding to the second subscription 604 may also be received by the first RX chain 610. However, in this case, the second RF signals 620 received by the first RX chain 610 may be treated as interference and discarded by the first baseband processor 608. Similarly, first RF signals 612 corresponding to the first subscription 602 may also be received by the second RX chain 614. However, in this case, the first RF signals 612 received by the second RX chain 614 may be treated as interference and discarded by the second baseband processor 616.

FIG. 6B provides an illustration of independent RF resources used for transmission between subscriptions of the MSIM device 600. For example, as shown in FIG. 6B, the MSIM device 600 includes a first subscription 602 and a second subscription 604. In some cases, the MSIM device 600 may have a limited number of RF resources and, as a result, TX chains may be split between the first subscription 602 and the second subscription 604. For example, as shown, the MSIM device 600 includes two TX chains split between the first subscription 602 and the second subscription 604, such as a first TX chain 630 corresponding to the first subscription 602 and a second TX chain 632 corresponding to the second subscription 604.

The first TX chain 630 may be used to transmit first RF signals 634 corresponding to the first subscription 602. For example, when transmitting data corresponding to the first subscription 602, the data may be generated in the protocol layers 610 and provided to the first baseband processor 608. The first baseband processor 608 encodes the data from the protocol layers 610 and modulates the encoded data with a first baseband frequency to generate the first RF signals 634. Thereafter, the first RF signals 634 may be up-converted by an RF up-converter 638 of the first TX chain 630 and amplified by an amplifier 640 of the first TX chain 630. Thereafter, the first RF signals 634 may be transmitted using an antenna in a first set of time-frequency resources.

Similarly, the second TX chain 632 may be used to transmit second RF signals 636 corresponding to the second subscription 604. For example, when transmitting data corresponding to the second subscription 604, the data may be generated in the protocol layer 618 layers and provided to the second baseband processor 616. The second baseband processor 616 encodes the data from the protocol layers 618 and modulates the encoded data with a second baseband frequency to generate the second RF signals 636. Thereafter, the second RF signals may be up-converted by an RF up-converter 642 of the second TX chain 632 and amplified by an amplifier 644 of the second TX chain 632. Thereafter, the second RF signals 636 may be transmitted using an antenna in a second set of time-frequency resources.

As can be seen, when MSIM operation is used by a UE, RF resources may be split between subscriptions of the UE when transmitting and receiving RF signals. As described above, splitting RF resources between subscriptions may significantly affect throughput and lead to performance loss associated with each of the subscriptions. Accordingly, aspects of the present disclosure provide techniques for reducing this performance loss associated with MSIM operation. For example, in some cases, these techniques may involve using a common or shared set of RF resources (e.g., TX/RX chains) when transmitting and receiving RF signals corresponding to different subscriptions.

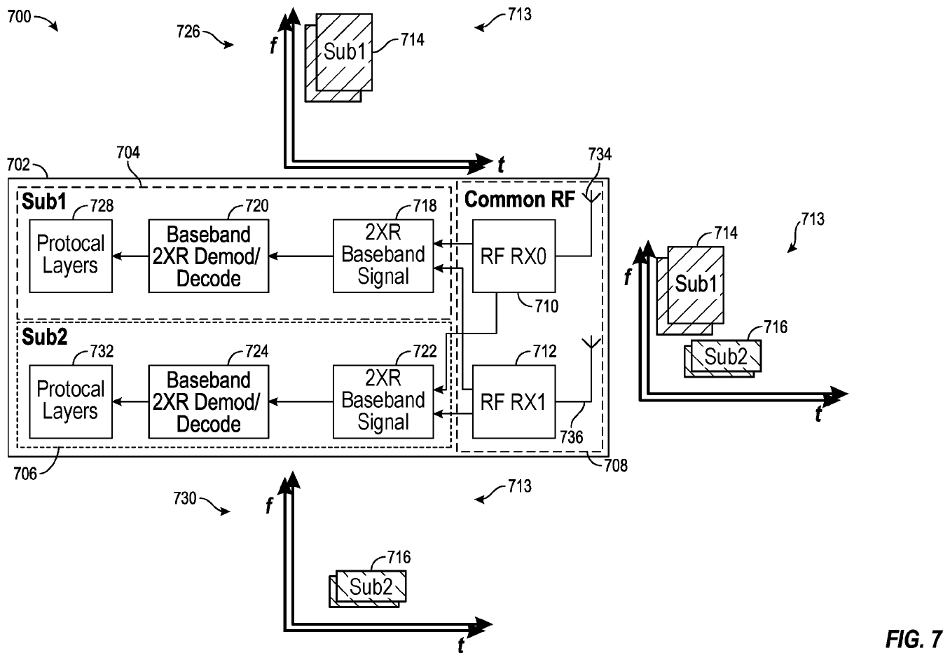

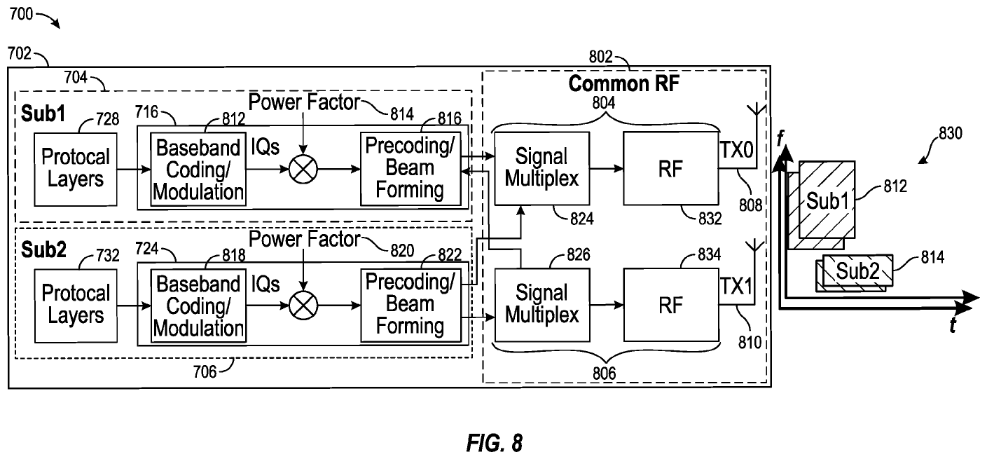

For example, rather than receiving RF signals corresponding to each different subscription using a separate respective RX chain, all RX chains may be shared between the different subscriptions and used to receive the RF signals corresponding to the different subscriptions. In other words, each of the RX chains may be used to receive the RF signals corresponding to each of the different subscriptions. Similarly, rather than transmitting RF signals corresponding to each different subscription using a separate respective TX chain, RF signals for each different subscription may be multiplexed together and transmitted using a shared set of TX chains. Accordingly, by using a shared set of RF resources (e.g., TX/RX chains) when transmitting and receiving RF signals corresponding to different subscriptions, throughput associated with these subscriptions may be improved and performance loss reduced or avoided. These techniques are described in greater detail below with respect to FIGS. 7 and 8.

For example, FIG. 7 illustrates a UE 700 including RF resources 702 that may be used to receive RF signals corresponding to different subscriptions using a shared set of RX chains. As shown, the UE 700 includes a first subscription 704 and a second subscription 706. In order to reduce performance loss associated with MSIM operation and achieve a similar receiving capability as compared to single-SIM operation, the UE 700 may use a shared set of RX chains 710 when receiving RF signals for the first subscription 704 and the second subscription 706. In the example shown in FIG. 7, the shared set of RX chains 708 include a first RX chain 710 and a second RX chain 712. However, the shared set of RX chains 708 may include more than two RX chains. In some cases, the shared set of RX chains 708 include at least a shared set of RF antennas, such as a first RF antenna 734 and a second RF antenna 736. In some cases, the first RX chain 710 and the second RX chain 712 in the shared set of RX chains 708 may be examples of the RX chain/RX path 504 illustrated in FIG. 5.

As shown, the shared set of RX chains 708 may be used to receive a plurality of RF signals in a set of time-frequency resources 713, such as first RF signals 714 corresponding to first subscription 704 of the UE 700 and second RF signals 716 corresponding to the second subscription 706. When using the shared set of RX chains 708 to receive the plurality of RF signals, the first RF signals 714 corresponding to the first subscription 704 and the second RF signals 716 may be received by each of the first RX chain 710 and the second RX chain 712 in the shared set of RX chains 708.

Thereafter, the plurality of RF signals received using the shared set of RX chains may be provided to a respective baseband processor for each of the first subscription 704 and the second subscription 706. For example, as shown, the plurality of RF signals received using the first RX chain 710 and received using the second RX chain 712 may be merged as shown at 718 to form a 2RX baseband signal and provided to a first baseband processor 720 corresponding to the first subscription 704 for further processing. Similarly, as shown, the plurality of RF signals received using the first RX chain 710 and received using the second RX chain 712 may be merged as shown at 722 to form a 2RX baseband signal and provided to a second baseband processor 724 corresponding to the second subscription 706 for further processing.

Thereafter, as shown at 726, the first baseband processor 720 extracts, from the plurality of RF signals, the first RF signals 714 based on a first time-frequency resource location allocated to the first RF signals 714 in the set of time-frequency resources 713. The first baseband processor 720 may then demodulate the first RF signals 714 to obtain first demodulated RF signals. Thereafter, the first baseband processor 720 decodes the first demodulated RF signals to obtain first decoded RF signals, which may be provided to protocol layers 728 of the UE 700.

Similarly, as shown at 730, the second baseband processor 724 extracts, from the plurality of RF signals, the second RF signals 716 based on a second time-frequency resource location allocated to the second RF signals 716 in the set of time-frequency resources 713. The second baseband processor 724 may then demodulate the second RF signals 716 to obtain second demodulated RF signals. Thereafter, the second baseband processor 724 decodes the second demodulated RF signals to obtain second decoded RF signals, which may be provided to protocol layers 732 of the UE 700. As can be seen, the techniques described above enable the UE 700 to use all RX chains (e.g., the first RX chain 810 and the second RX chain 812) to receive RF signals corresponding to each of its subscriptions (e.g., the first subscription 704 and the second subscription 706), which improves throughput associated MSIM operation and decreases performance loss.

In some cases, using multiple RX chains (e.g., the first RX chain 710 and the second RX chain 712) to receive RF signals may consume a significant amount of power. In some cases, to help reduce power consumption at the UE 700, the UE 700 may be configured to enable a sleep mode associated with at least one RX chain of the shared set of RX chains when one or more criteria are satisfied, such as when a signal quality associated with the plurality of RF signals satisfies a threshold signal quality. For example, in some cases, the UE 700 may be configured to determine that a signal quality associated with receiving the plurality of RF signals satisfies a threshold signal quality. In such cases, based on the determination, the UE 700 may enable a sleep mode for at least one RX chain (e.g., the first RX chain 710 or the second RX chain 712) of the shared set of RX chains to reduce power consumption.

FIG. 8 illustrates the UE 700 including RF resources 702 that may be used to transmit RF signals corresponding to different subscriptions (e.g., the first subscription 704 and the second subscription 706) using a shared set of TX chains. For example, in order to reduce performance loss associated with MSIM operation and achieve a similar transmitting capability as compared to single-SIM operation, the UE 700 may use a shared set of TX chains 802 when transmitting RF signals for the first subscription 704 and the second subscription 706. In the example shown in FIG. 8, the shared set of TX chains 802 include a first TX chain 804 and a second TX chain 806. However, the shared set of TX chains 802 may include more than two TX chains. In some cases, the shared set of TX chains 802 include at least a shared set of RF antennas, such as a first RF antenna 808 and a second RF antenna 810. In some cases, the first TX chain 804 and the second TX chain 806 in the shared set of TX chains 802 may be examples of the TX chain/TX path 502 illustrated in FIG. 5.

In order to transmit data corresponding to the first subscription 704, first RF signals may be generated in the protocol layers 728 and provided to the first baseband processor 720. The first baseband processor 720 may process the first RF signals, corresponding to the first subscription 704, for transmission using the shared set of TX chains 802. For example, as shown at 812 in FIG. 8, the first baseband processor 720 may encode the first RF signals using an encoding scheme (e.g., low-density parity-check (LDPC) encoding, polar encoding, etc.) to obtain first encoded RF signals. Thereafter, also shown at 812, the first baseband processor 720 modulates the first encoded RF signals with a first baseband frequency to obtain first modulated RF signals (e.g., IQ signals). Thereafter, as shown at 814, the first baseband processor 720 applies a first power factor to the first modulated RF signals (e.g., to scale a transmission power associated with transmitting the first modulated RF signals) to obtain first power-adjusted modulated RF signals. The first baseband processor 720 may then apply a first precoder (e.g., beam forming matrix) to the first power-adjusted modulated RF signals to obtain first precoded RF signals, as shown at 816.

In order to transmit data corresponding to the second subscription 706, second RF signals may be generated in the protocol layers 732 and provided to the second baseband processor 724. The second baseband processor 724 may process the second RF signals, corresponding to the second subscription 706, for transmission using the shared set of TX chains 802. For example, as shown at 818 in FIG. 8, the second baseband processor 724 may encode the second RF signals using an encoding scheme (e.g., LDPC encoding, polar encoding, etc.) to obtain second encoded RF signals. Thereafter, also shown at 818, the second baseband processor 724 modulates the second encoded RF signals with a second baseband frequency to obtain second modulated RF signals (e.g., IQ signals). Thereafter, as shown at 820, the second baseband processor 724 applies a second power factor to the second modulated RF signals (e.g., to scale a transmission power associated with transmitting the second modulated RF signals) to obtain second power-adjusted modulated RF signals. The second baseband processor 724 may then apply a second precoder (e.g., beam forming matrix) to the first power-adjusted modulated RF signals to obtain second precoded RF signals, as shown at 822.

Thereafter, the first pre-coded RF signals and the second precoded RF signals may be input into a respective signal multiplexer for each TX chain in the shared set of TX chains 802. For example, as shown, the first pre-coded RF signals corresponding to the first subscription 704 and the second precoded RF signals corresponding to the second subscription 706 may be input into a first signal multiplexer 824 of the first TX chain 804 of the shared set of TX chains 802. Similarly, as shown, the first pre-coded RF signals corresponding to the first subscription 704 and the second precoded RF signals corresponding to the second subscription 706 may also be input into a second signal multiplexer 826 of the second TX chain 806 of the shared set of TX chains 802.

The first signal multiplexer 824 and the second signal multiplexer 826 may each be configured to multiplex the first pre-coded RF signals corresponding to the first subscription 704 with the second precoded RF signals corresponding to the second subscription 706 within a set of time-frequency resources 830 to obtain multiplexed RF signals. Thereafter, an RF interface 832 of the first TX chain 804 and an RF interface 834 of the second TX chain 806 may be configured to transmit the multiplexed RF signals in the set of time-frequency resources 830 (e.g., via the first RF antenna 808 and the second RF antenna 810). As can be seen, the techniques described above enable the UE 700 to use all TX chains (e.g., the first TX chain 804 and the second TX chain 806) to transmit RF signals corresponding to each of its subscriptions (e.g., the first subscription 704 and the second subscription 706), which improves throughput associated MSIM operation and decreases performance loss.

In some cases, to ensure proper operation when transmitting RF signals using the shared set of TX chains 802 and receiving RF signals using the shared set of RX chains 708 coordination of one or more parameters may be needed between the first subscription 704 and second subscription 706. For example, in some cases, the one or more parameters may include coordinated sleep and wakeup scheduling parameters between the first subscription and the second subscription. As one example, only when both the first subscription 704 and second subscription 706 vote to enable a sleep mode parameter may the shared set of TX chains and/or shared set of RX chains be put to sleep. Otherwise, the shared set of TX chains and/or shared set of RX chains may remain awake and ready to transmit or receive RF signals.

In some cases, the one or more parameters may include coordinated RF tuning parameters between the first subscription and the second subscription. For example, in some cases, when using the shared set of TX chains 802, a tuning capability of the first TX chain 804 corresponding to the first subscription 704 and the second TX chain 806 corresponding to the second subscription 706 may need to be taken into account. More specifically, the first TX chain 804 and the second TX 806 may need to be capable of tuning to the respective frequency locations within the time-frequency resources 830 in order to transmit the RF signals for each of the subscriptions. In some cases, if either TX chain is unable to tune to one of the respective frequency locations, the shared set of TX chains 802 may not be used.

Similarly, when using the shared set of RX chains 708, a tuning capability of the first RX chain 710 corresponding to the first subscription 704 and the second RX chain 712 corresponding to the second subscription 706 may need to be taken into account. More specifically, the first RX chain 710 and the second RX 712 may need to be capable of tuning to the respective frequency locations within the time-frequency resources 713 in order to receive the RF signals for each of the subscriptions. In some cases, if either RX chain is unable to tune to one of the respective frequency locations, the shared set of RX chains 708 may not be used.

In some cases, the one or more parameters may include coordinated measurement gap scheduling parameters between the first subscription 704 and the second subscription 706. In some cases, the coordinated measurement gap scheduling parameters may include at least one of inter-frequency or inter-radio access technology (IRAT) measurement scheduling parameters. For example, in some cases, common measure results may be shared between subscriptions in order to decrease measurement gaps needed to perform the inter-frequency/IRAT measurements for the first subscription 704 and the second subscription 706.

In some cases, when one subscription opens a measurement gap to perform the inter-frequency/IRAT measurements and the other subscription is in a legacy receiving/transmitting mode, MSIM full concurrency (FC)/diversity tune away (DTA) logic may be used to mitigate the impact of the measurement gap. In such cases, it may be beneficial to keep at least one RX chain for the legacy receiving subscription. For example, if the UE 700 is receiving with four common/shared RX chains, but one subscription needs to perform inter-f/IRAT measurements, this subscription needs to tune to a measurement frequency for a short while (e.g., 6 ms) to perform the inter-f/IRAT measurements. If the UE 700 tunes all four RX chains to the measurement frequency, this may interrupt reception of transmissions for the other subscription. In this case, if the measurement frequency is within the common/shared RX chains' supported bandwidth, the UE 700 may be able to perform joint-tuning of the four RX chains to do the inter-f/IRAT measurements for the one subscription while also allowing reception for the other subscription in parallel. This is known as full concurrency (FC) and may not affect the performance of the other subscription

If, however, the measurement frequency is not within the common/share RX chains' supported bandwidth, the UE 700 may tune some of the RX chains (e.g., 1-3 RX chains) away for a short while for the inter-f/IRAT measurements, while leaving a remaining number of RX chains for the other subscription for receiving of transmissions. This is what is known as a diversity tune away (DTA). While there may be a slight performance impact to the other subscription, the duration of this performance impact is insignificant. After the inter-f/IRAT measurements are finished, the UE 700 can return back to using the four common/shared RX chains for receiving. During the DTA, the other subscription needs at least one RX chain to continue receiving transmissions. If additional RX chains remain for the other subscription during the DTA, the impact to the other subscription will be even less.

In some cases, the one or more parameters may include a coordinated automatic gain control (AGC) parameter between the first subscription and the second subscription. For example, when operating with multiple SIMs, different subscriptions may have different receiving signal strength as they may camp on different cells. AGC may be used to control an input amplifier level to provide the UE 700 with an optimal RF receiving range. However, when using common/shared RF resources (e.g., TX/RX chains), the UE 700 may not be able to perform AGC adjusting per subscription. As such, the UE 700 may coordinate an AGC gain state between subscriptions in order to obtain an optimal RF receiving range for each subscription.

In some cases, the one or more parameters may include a coordinated baseband processor tracking loop parameter between the first subscription and the second subscription. For example, in some cases, the baseband processor for each subscription may need to calculate its own metric using its own valid narrow band data. For example, if two subscriptions are operate under a same cell or a same frequency, these subscriptions may have similar channel estimation, timing and frequency offsets. In this case, the baseband processors may coordinate tracking of signals for the two subscriptions. In some cases, if there is too much difference between two subscriptions signals, such as a large timing difference, the baseband processors of the two subscriptions may need to keep their own tracking loops to make sure each subscription can decode a received signal with their correct timing/frequency offsets.

In some cases, the one or more parameters may include a coordinated channel state feedback (CSF) reporting parameter between the first subscription and the second subscription. In some cases, the one or more parameters may include a coordinated narrowband measurement parameter between the first subscription and the second subscription.

### Example Operations of a User Equipment

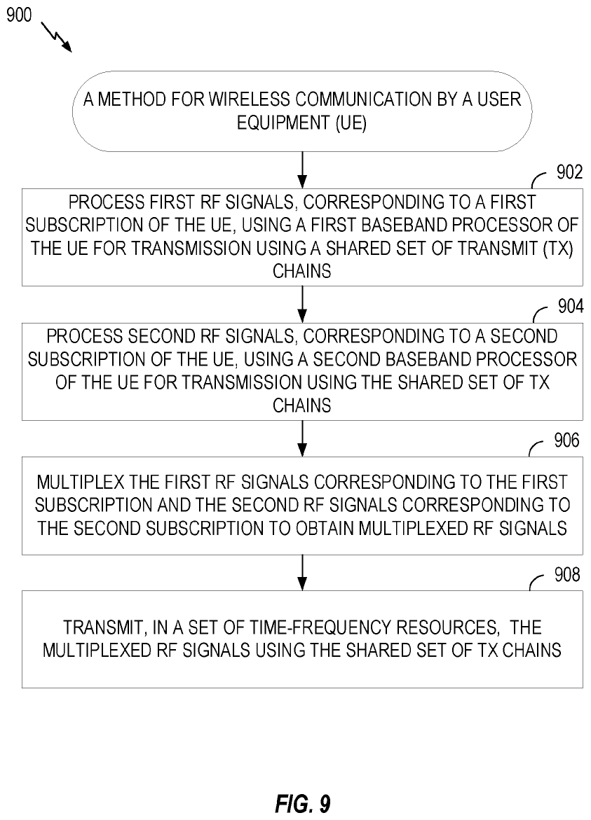

FIG. 9 illustrates a method 900 for wireless communications that may be performed by a UE (e.g., UE 104 of FIGS. 1 and 3 and/or UE 700 illustrated in FIGS. 7 and 8), for example, for receiving RF signals using a shared set of RX chains.

Method 900 begins in step 910 with receiving, using a shared set of RX chains, a plurality of RF signals in a set of time-frequency resources. In some cases, wherein the plurality of RF signals include first RF signals corresponding to a first subscription of the UE.

In step 920, the UE processes the first RF signals using a first baseband processor of the UE associated with the first subscription;

In step 930, the UE processes the second RF signals using a second baseband processor of the UE associated with the second subscription.

In some cases, processing the first RF signals in step 920 may include extracting, from the plurality of RF signals, the first RF signals based on a first time-frequency resource location allocated to the first RF signals in the set of time-frequency resources. In some cases, processing the first RF signals in step 920 may further include demodulating the first RF signals using the first baseband processor to obtain first demodulated RF signals. In some cases, processing the first RF signals in step 920 may further include decoding the first demodulated RF signals using the first baseband processor to obtain first decoded RF signals.

In some cases, processing the second RF signals in step 930 may include extracting, from the plurality of RF signals, the second RF signals based on a second time-frequency resource location allocated to the second RF signals in the set of time-frequency resources. In some cases, processing the second RF signals in step 930 may further include demodulating the second RF signals using the second baseband processor to obtain second demodulated RF signals. In some cases, processing the second RF signals in step 930 may include decoding the second demodulated RF signals using the second baseband processor to obtain second decoded RF signals.

In some cases, receiving the plurality of RF signals in step 910, including the first RF signals and the second RF signals, is based on one or more parameters coordinated between the first subscription and the second subscription.

In some cases, the one or more parameters comprise at least one of: coordinated sleep and wakeup scheduling parameters between the first subscription and the second subscription, coordinated RF tuning parameters between the first subscription and the second subscription, coordinated measurement gap scheduling parameters between the first subscription and the second subscription, or a coordinated AGC parameter between the first subscription and the second subscription.

In some cases, the shared set of RX chains include at least a shared set of RF antennas.

In some cases, method 900 further includes determining that a signal quality associated with receiving the plurality of RF signals satisfies a threshold signal quality.

In some cases, method 900 further includes, based on the determination, enabling a sleep mode for at least one RX chain of the shared set of RX chains.

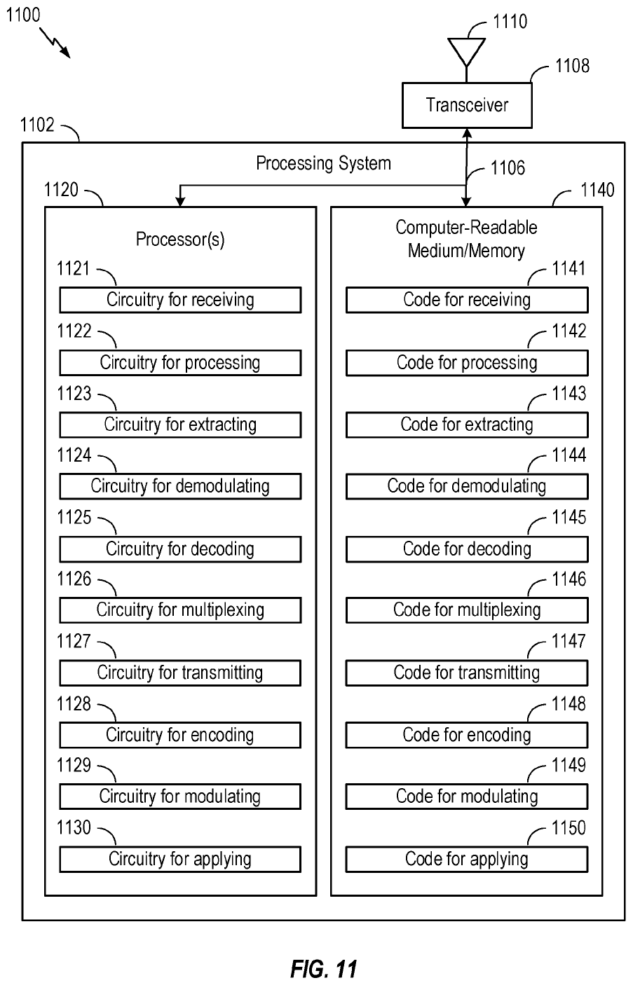

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

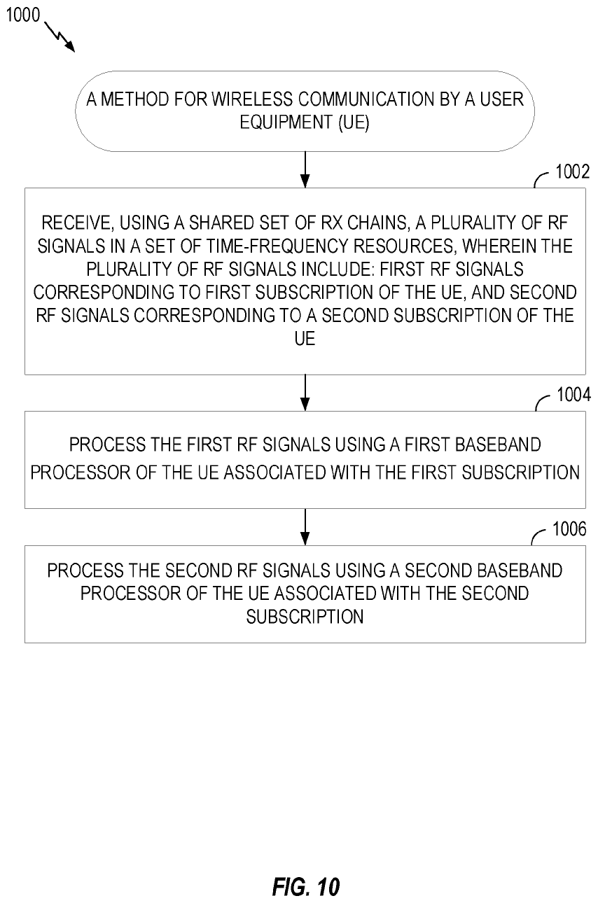

FIG. 10 illustrates a method 1000 for wireless communications that may be performed by a UE (e.g., UE 104 of FIGS. 1 and 3 and/or UE 700 illustrated in FIGS. 7 and 8), for example, for transmitting RF signals using a shared set of TX chains.

Method 1000 begins in step 1010 with processing first RF signals, corresponding to a first subscription of the UE, using a first baseband processor of the UE for transmission using a shared set of TX chains.

In step 1020, the UE processes second RF signals, corresponding to a second subscription of the UE, using a second baseband processor of the UE for transmission using the shared set of TX chains.

In step 1030, the UE multiplexes the first RF signals corresponding to the first subscription and the second RF signals corresponding to the second subscription to obtain multiplexed RF signals.

In step 1040, the UE transmits, in a set of time-frequency resources, the multiplexed RF signals using the shared set of TX chains.

In some cases, processing the first RF signals in step 1010 includes encoding the first RF signals using the first baseband processor of the UE to obtain first encoded RF signals. In some cases, processing the first RF signals in step 1010 further includes modulating the first encoded RF signals with a first baseband frequency using the first baseband processor of the UE to obtain first modulated RF signals. In some cases, processing the first RF signals in step 1010 further includes applying a first power factor to the first modulated RF signals to obtain first power-adjusted modulated RF signals. In some cases, processing the first RF signals in step 1010 further includes applying a first precoder to the first power-adjusted modulated RF signals to obtain first precoded RF signals.

In some cases, processing the second RF signals in step 1020 includes encoding the second RF signals using the second baseband processor of the UE to obtain second encoded RF signals. In some cases, processing the second RF signals in step 1020 further includes modulating the second encoded RF signals with a second baseband frequency using the second baseband processor of the UE to obtain second modulated RF signals. In some cases, processing the second RF signals in step 1020 further includes applying a second power factor to the second modulated RF signals to obtain second power-adjusted modulated RF signals. In some cases, processing the second RF signals in step 1020 further includes applying a second precoder to the second power-adjusted modulated RF signals to obtain second precoded RF signals.

In some cases, multiplexing the first RF signals and the second RF signals in step 1030 comprises multiplexing the first precoded RF signals with the second precoded RF signals to obtain the multiplexed RF signals.

In some cases, transmitting the multiplexed first RF signals and second RF signals in step 1040 is based on one or more parameters coordinated between the first subscription and the second subscription.

In some cases, the one or more parameters comprise at least one of: coordinated sleep and wakeup scheduling parameters between the first subscription and the second subscription, coordinated RF tuning parameters between the first subscription and the second subscription, coordinated measurement gap scheduling parameters between the first subscription and the second subscription, or a coordinated AGC parameter between the first subscription and the second subscription.

In some cases, the shared set of TX chains include at least a shared set of RF antennas.

In one aspect, method 1000, or any aspect related to it, may be performed by an apparatus, such as communications device 1100 of FIG. 11, which includes various components operable, configured, or adapted to perform the method 1000.

Communications device 1100 is described below in further detail.

Note that FIG. 10 is just one example of a method, and other methods including fewer, additional, or alternative steps are possible consistent with this disclosure.

### Example Communications Device

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1140 via a bus 1106. In certain aspects, the computer-readable medium/memory 1140 is configured to store instructions (e.g., computer-executable code) that when executed by the one or more processors 1120, cause the one or more processors 1120 to perform the method 900 described with respect to FIG. 9 and/or the method 1000 described with respect to FIG. 10, or any aspects related to them. Note that reference to a processor performing a function of communications device 1100 may include one or more processors performing that function of communications device 1100.

In the depicted example, computer-readable medium/memory 1140 stores code (e.g., executable instructions) for receiving 1141, code for processing 1142, code for extracting 1143, code for demodulating 1144, code for decoding 1145, code for multiplexing 1146, code for transmitting 1147, code for encoding 1148, code for modulating 1149, and code for applying 1150. Processing of the code 1141-1150 may cause the communications device 1100 to perform the method 900 described with respect to FIG. 9 and/or the method 1000 described with respect to FIG. 10, or any aspect related to it.

The one or more processors 1120 include circuitry configured to implement (e.g., execute) the code stored in the computer-readable medium/memory 1140, including circuitry for receiving 1121, circuitry for processing 1122, circuitry for extracting 1123, circuitry for demodulating 1124, circuitry for decoding 1125, circuitry for multiplexing 1126, circuitry for transmitting 1127, circuitry for encoding 1128, circuitry for modulating 1129, and circuitry for applying 1130. Processing with circuitry 1121-1130 may cause the communications device 1100 to perform the method 900 described with respect to FIG. 9 and/or the method 1000 described with respect to FIG. 10, or any aspects related to them.

Various components of the communications device 1100 may provide means for performing the method 900 described with respect to FIG. 9 and/or the method 1000 described with respect to FIG. 10, or any aspects related to them. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11.

### EXAMPLE CLAUSES

Implementation examples are described in the following numbered clauses:

Clause 1: A method of wireless communication by a user equipment (UE), comprising: receiving, using a shared set of receive (RX) chains, a plurality of radio frequency (RF) signals in a set of time-frequency resources, wherein the plurality of RF signals include: first RF signals corresponding to first subscription of the UE, and second RF signals corresponding to a second subscription of the UE; processing the first RF signals using a first baseband processor of the UE associated with the first subscription; processing the second RF signals using a second baseband processor of the UE associated with the second subscription.

Clause 2: The method of Clause 1, wherein processing the first RF signals comprises: extracting, from the plurality of RF signals, the first RF signals based on a first time-frequency resource location allocated to the first RF signals in the set of time-frequency resources; demodulating the first RF signals using the first baseband processor to obtain first demodulated RF signals; and decoding the first demodulated RF signals using the first baseband processor to obtain first decoded RF signals.

Clause 3: The method of any one of Clauses 1-2, wherein processing the second RF signals comprises: extracting, from the plurality of RF signals, the second RF signals based on a second time-frequency resource location allocated to the second RF signals in the set of time-frequency resources; demodulating the second RF signals using the second baseband processor to obtain second demodulated RF signals; and decoding the second demodulated RF signals using the second baseband processor to obtain second decoded RF signals.

Clause 4: The method of any one of Clauses 1-3, wherein receiving the plurality of RF signals, including the first RF signals and the second RF signals, is based on one or more parameters coordinated between the first subscription and the second subscription.

Clause 5: The method of Clause 4, wherein the one or more parameters comprise at least one of: coordinated sleep and wakeup scheduling parameters between the first subscription and the second subscription; coordinated RF tuning parameters between the first subscription and the second subscription; coordinated measurement gap scheduling parameters between the first subscription and the second subscription; or a coordinated automatic gain control (AGC) parameter between the first subscription and the second subscription.

Clause 6: The method of any one of Clauses 1-5, wherein the shared set of RX chains include at least a shared set of RF antennas.

Clause 7: The method of any one of Clauses 1-6, further comprising determining that a signal quality associated with receiving the plurality of RF signals satisfies a threshold signal quality.

Clause 8: The method of Clause 8, further comprising, based on the determination, enabling a sleep mode for at least one RX chain of the shared set of RX chains.

Clause 9: A method of wireless communication by a user equipment (UE), comprising: processing first radio frequency (RF) signals, corresponding to a first subscription of the UE, using a first baseband processor of the UE for transmission using a shared set of transmit (TX) chains; processing second RF signals, corresponding to a second subscription of the UE, using a second baseband processor of the UE for transmission using the shared set of TX chains; multiplexing the first RF signals corresponding to the first subscription and the second RF signals corresponding to the second subscription to obtain multiplexed RF signals; and transmitting, in a set of time-frequency resources, the multiplexed RF signals using the shared set of TX chains.

Clause 10: The method of Clause 9, wherein processing the first RF signals comprises one or more of: encoding the first RF signals using the first baseband processor of the UE to obtain first encoded RF signals; modulating the first encoded RF signals with a first baseband frequency using the first baseband processor of the UE to obtain first modulated RF signals; applying a first power factor to the first modulated RF signals to obtain first power-adjusted modulated RF signals; and applying a first precoder to the first power-adjusted modulated RF signals to obtain first precoded RF signals.

Clause 11: The method of Clause 10, wherein processing the second RF signals comprises: encoding the second RF signals using the second baseband processor of the UE to obtain second encoded RF signals; modulating the second encoded RF signals with a second baseband frequency using the second baseband processor of the UE to obtain second modulated RF signals; applying a second power factor to the second modulated RF signals to obtain second power-adjusted modulated RF signals; and applying a second precoder to the second power-adjusted modulated RF signals to obtain second precoded RF signals.

Clause 12: The method of Clause 11, wherein multiplexing the first RF signals and the second RF signals comprises multiplexing the first precoded RF signals with the second precoded RF signals to obtain the multiplexed RF signals.

Clause 13: The method of any one of Clauses 9-11, wherein transmitting the multiplexed first RF signals and second RF signals is based on one or more parameters coordinated between the first subscription and the second subscription.

Clause 14: The method of Clause 13, wherein the one or more parameters comprise at least one of: coordinated sleep and wakeup scheduling parameters between the first subscription and the second subscription; coordinated RF tuning parameters between the first subscription and the second subscription; coordinated measurement gap scheduling parameters between the first subscription and the second subscription; or a coordinated automatic gain control (AGC) parameter between the first subscription and the second subscription.

Clause 15: The method of any one of Clauses 9-14, wherein the shared set of TX chains include at least a shared set of RF antennas.

Clause 16: An apparatus, comprising: a memory comprising executable instructions; and a processor configured to execute the executable instructions and cause the apparatus to perform a method in accordance with any one of Clauses 1-15.

Clause 17: An apparatus, comprising means for performing a method in accordance with any one of Clauses 1-15.

Clause 18: A non-transitory computer-readable medium comprising executable instructions that, when executed by a processor of an apparatus, cause the apparatus to perform a method in accordance with any one of Clauses 1-15.

Clause 19: A computer program product embodied on a computer-readable storage medium comprising code for performing a method in accordance with any one of Clauses 1-15.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a user equipment (UE), comprising:
receiving, using a shared set of receive (RX) chains, a plurality of radio frequency (RF) signals in a set of time-frequency resources, wherein the plurality of RF signals include:
first RF signals corresponding to first subscription of the UE, and
second RF signals corresponding to a second subscription of the UE;
processing the first RF signals using a first baseband processor of the UE associated with the first subscription; and
processing the second RF signals using a second baseband processor of the UE associated with the second subscription.

2. The method of claim 1, wherein processing the first RF signals comprises:
extracting, from the plurality of RF signals, the first RF signals based on a first time-frequency resource location allocated to the first RF signals in the set of time-frequency resources;
demodulating the first RF signals using the first baseband processor to obtain first demodulated RF signals; and
decoding the first demodulated RF signals using the first baseband processor to obtain first decoded RF signals.

3. The method of claim 1, wherein processing the second RF signals comprises:
extracting, from the plurality of RF signals, the second RF signals based on a second time-frequency resource location allocated to the second RF signals in the set of time-frequency resources;
demodulating the second RF signals using the second baseband processor to obtain second demodulated RF signals; and
decoding the second demodulated RF signals using the second baseband processor to obtain second decoded RF signals.

4. The method of claim 1, wherein receiving the plurality of RF signals, including the first RF signals and the second RF signals, is based on one or more parameters coordinated between the first subscription and the second subscription.

5. The method of claim 4, wherein the one or more parameters comprise at least one of:
coordinated sleep and wakeup scheduling parameters between the first subscription and the second subscription;
coordinated RF tuning parameters between the first subscription and the second subscription;
coordinated measurement gap scheduling parameters between the first subscription and the second subscription; or
a coordinated automatic gain control (AGC) parameter between the first subscription and the second subscription.

6. The method of claim 1, wherein the shared set of RX chains include at least a shared set of RF antennas.

7. The method of claim 1, further comprising determining that a signal quality associated with receiving the plurality of RF signals satisfies a threshold signal quality.

8. The method of claim 7, further comprising, based on the determination, enabling a sleep mode for at least one RX chain of the shared set of RX chains.

9. A method of wireless communication by a user equipment (UE), comprising:
processing first radio frequency (RF) signals, corresponding to a first subscription of the UE, using a first baseband processor of the UE for transmission using a shared set of transmit (TX) chains;
processing second RF signals, corresponding to a second subscription of the UE, using a second baseband processor of the UE for transmission using the shared set of TX chains;
multiplexing the first RF signals corresponding to the first subscription and the second RF signals corresponding to the second subscription to obtain multiplexed RF signals; and
transmitting, in a set of time-frequency resources, the multiplexed RF signals using the shared set of TX chains.

10. The method of claim 9, wherein processing the first RF signals comprises one or more of:
encoding the first RF signals using the first baseband processor of the UE to obtain first encoded RF signals;
modulating the first encoded RF signals with a first baseband frequency using the first baseband processor of the UE to obtain first modulated RF signals;
applying a first power factor to the first modulated RF signals to obtain first power-adjusted modulated RF signals; and
applying a first precoder to the first power-adjusted modulated RF signals to obtain first precoded RF signals.

11. The method of claim 10, wherein processing the second RF signals comprises:
encoding the second RF signals using the second baseband processor of the UE to obtain second encoded RF signals;
modulating the second encoded RF signals with a second baseband frequency using the second baseband processor of the UE to obtain second modulated RF signals;
applying a second power factor to the second modulated RF signals to obtain second power-adjusted modulated RF signals; and
applying a second precoder to the second power-adjusted modulated RF signals to obtain second precoded RF signals.

12. The method of claim 11, wherein multiplexing the first RF signals and the second RF signals comprises multiplexing the first precoded RF signals with the second precoded RF signals to obtain the multiplexed RF signals.

13. The method of claim 9, wherein transmitting the multiplexed first RF signals and second RF signals is based on one or more parameters coordinated between the first subscription and the second subscription.

14. The method of claim 13, wherein the one or more parameters comprise at least one of:
coordinated sleep and wakeup scheduling parameters between the first subscription and the second subscription;
coordinated RF tuning parameters between the first subscription and the second subscription;
coordinated measurement gap scheduling parameters between the first subscription and the second subscription; or
a coordinated automatic gain control (AGC) parameter between the first subscription and the second subscription.

15. The method of claim 9, wherein the shared set of TX chains include at least a shared set of RF antennas.

16. An apparatus, comprising:
a memory comprising executable instructions; and
a processor configured to execute the executable instructions and cause the apparatus to:
receive, using a shared set of receive (RX) chains, a plurality of radio frequency (RF) signals in a set of time-frequency resources, wherein the plurality of RF signals include:
first RF signals corresponding to first subscription of the UE, and
second RF signals corresponding to a second subscription of the UE;
process the first RF signals using a first baseband processor of the UE associated with the first subscription; and
process the second RF signals using a second baseband processor of the UE associated with the second subscription.

17. The apparatus of claim 16, wherein, in order to process the first RF signals, the processor is further configured to cause the apparatus to:
extract, from the plurality of RF signals, the first RF signals based on a first time-frequency resource location allocated to the first RF signals in the set of time-frequency resources;
demodulate the first RF signals using the first baseband processor to obtain first demodulated RF signals; and
decode the first demodulated RF signals using the first baseband processor to obtain first decoded RF signals.

18. The apparatus of claim 16, wherein, in order to process the second RF signals, the processor is further configured to cause the apparatus to:
extract, from the plurality of RF signals, the second RF signals based on a second time-frequency resource location allocated to the second RF signals in the set of time-frequency resources;
demodulate the second RF signals using the second baseband processor to obtain second demodulated RF signals; and
decode the second demodulated RF signals using the second baseband processor to obtain second decoded RF signals.

19. The apparatus of claim 16, wherein the processor is configured to cause the apparatus to receive the plurality of RF signals, including the first RF signals and the second RF signals, based on one or more parameters coordinated between the first subscription and the second subscription.

20. The apparatus of claim 19, wherein the one or more parameters comprise at least one of:
coordinated sleep and wakeup scheduling parameters between the first subscription and the second subscription;
coordinated RF tuning parameters between the first subscription and the second subscription;
coordinated measurement gap scheduling parameters between the first subscription and the second subscription; or
a coordinated automatic gain control (AGC) parameter between the first subscription and the second subscription.

21. The apparatus of claim 16, wherein the shared set of RX chains include at least a shared set of RF antennas.

22. The apparatus of claim 16, wherein the processor is further configured to cause the apparatus to determine that a signal quality associated with receiving the plurality of RF signals satisfies a threshold signal quality.

23. The apparatus of claim 22, wherein the processor is further configured to cause the apparatus to, based on the determination, enable a sleep mode for at least one RX chain of the shared set of RX chains.

24. An apparatus, comprising:
a memory comprising executable instructions; and
a processor configured to execute the executable instructions and cause the apparatus to:
process first radio frequency (RF) signals, corresponding to a first subscription of the UE, using a first baseband processor of the UE for transmission using a shared set of transmit (TX) chains;
process second RF signals, corresponding to a second subscription of the UE, using a second baseband processor of the UE for transmission using the shared set of TX chains;
multiplex the first RF signals corresponding to the first subscription and the second RF signals corresponding to the second subscription to obtain multiplexed RF signals; and
transmit, in a set of time-frequency resources, the multiplexed RF signals using the shared set of TX chains.

25. The apparatus of claim 24, wherein, in order to process the first RF signals, the processor is further configured to cause the apparatus to:
encode the first RF signals using the first baseband processor of the UE to obtain first encoded RF signals;
modulate the first encoded RF signals with a first baseband frequency using the first baseband processor of the UE to obtain first modulated RF signals;
apply a first power factor to the first modulated RF signals to obtain first power-adjusted modulated RF signals; and
apply a first precoder to the first power-adjusted modulated RF signals to obtain first precoded RF signals.

26. The apparatus of claim 25, wherein, in order to process the second RF signals, the processor is further configured to cause the apparatus to:
encode the second RF signals using the second baseband processor of the UE to obtain second encoded RF signals;
modulate the second encoded RF signals with a second baseband frequency using the second baseband processor of the UE to obtain second modulated RF signals;
apply a second power factor to the second modulated RF signals to obtain second power-adjusted modulated RF signals; and
apply a second precoder to the second power-adjusted modulated RF signals to obtain second precoded RF signals.

27. The apparatus of claim 26, wherein, in order to multiplex the first RF signals and the second RF signals, the processor is further configured to cause the apparatus to multiplex the first precoded RF signals with the second precoded RF signals to obtain the multiplexed RF signals.

28. The apparatus of claim 24, wherein the processor is configured to cause the apparatus to transmit the multiplexed first RF signals and second RF signals based on one or more parameters coordinated between the first subscription and the second subscription.

29. The apparatus of claim 28, wherein the one or more parameters comprise at least one of:
coordinated sleep and wakeup scheduling parameters between the first subscription and the second subscription;
coordinated RF tuning parameters between the first subscription and the second subscription;
coordinated measurement gap scheduling parameters between the first subscription and the second subscription; or
a coordinated automatic gain control (AGC) parameter between the first subscription and the second subscription.

30. The apparatus of claim 24, wherein the shared set of TX chains include at least a shared set of RF antennas.
